(19) United States
(12) Patent Application Publication
(10) Pub. No.: US 2014/0041012 A1
(43) Pub. Date: Feb. 6, 2014

(54) SYSTEM FOR THE MANAGEMENT OF ACCESS POINTS

(71) Applicant: Telekom Malaysia Berhad, Kuala Lumpur (MY)

(72) Inventors: Yeoh Chun YEOW, Selangor Darul Ehsan (MY); Mohammad Harris BIN MOKHTAR, Selangor Darul Ehsan (MY)

(73) Assignee: Telekom Malaysia Berhad, Kuala Lumpur (MY)

(21) Appl. No.: 13/954,608

(22) Filed: Jul. 30, 2013

(30) Foreign Application Priority Data
Jul. 31, 2012 (MY) PI 2012003455

(51) Int. Cl. H04L 29/06

(52) U.S. Cl. CPC H04L 63/02
USPC 726/11

(57) ABSTRACT

A network management system for the management of remote networks located behind a firewall. A managed device establishes a connection with the firewall. The managed device then generates and transmits a data packet to the firewall. The firewall then redirects the data packet to a controller server. Based on the information contained in the data packet, the controller server will verify the authenticity of the managed device. Based on the outcome of the verification process, the controller server will then carry out the necessary actions.

### FIELD OF THE INVENTION

This invention relates to a network management system for the management of remote networks located behind a firewall. More particularly, this invention relates to a system for the management of access points located behind a firewall whereby, the access point is authenticated by the network management system and the authenticated access point will then be connected to a web server without the need for the authentication process to be repeated.

### PRIOR ART

Network elements such as access points, computers, servers, which may collectively be identified as managed devices, are conventionally managed by a network management system that monitors the configuration, performance and any faults in the managed devices. Whenever necessary, the network management system may transmit scripts to the managed devices. These scripts may contain instruction sets that will assist the managed devices to overcome any faults that may arise or these scripts may provide for the updating of the managed devices configurations.

As a security precaution, most managed devices typically reside behind a firewall. The firewall acts as an intermediary between the managed devices and computers/servers located external to the network of the managed devices. The firewall acts to inhibit unwanted access to or from the managed devices on the internal network. However, the presence of the firewall may also prevent the remote management of the managed devices, as the firewall will block incoming instructions and/or data that may be used to effect the remote management of the managed devices.

Several different internet protocols have been developed to enable the management and monitoring of managed devices located behind firewalls. These protocols often include objects and procedures for accessing information associated with a network attached device. The Simple Network Management Protocol (SNMP) is a relatively well-known management protocol that is used for managing and monitoring managed devices. SNMP includes a set of standards for network management including a protocol, database structure specification and a set of data objects. However, the implementation of a SNMP management system is not practical as a SNMP requires three basic components: an agent, a manager and a management information base. Thus, it would be advantageous if a simpler network management system could be provided for the management of access points located behind a firewall.

A system for the remote management of a computer network through a firewall is disclosed in U.S. Pat. No. 8,161,162 B1 as published on 17 Apr. 2012 in the names of Mark J. Sutherland et al. This patent discloses the remote management of a computer located behind a firewall. Communications between the remote managing server and the computer are carried out using Transmission Control Protocol and Internet Protocol (TCP/IP) such as Hypertext Transport Protocol (HTTP) and Hypertext Transport Protocol Secure (HTTPS). The managed computers are programmed to initiate communication with the remote server at regular intervals. If the remote server determines that a managed computer requires updates, the remote server will send the necessary instructions via the established communication protocol to the respective managed computer.

A method and system for updating a browser's content is described in U.S. Pat. No. 7,987,246 B2 as published on 26 Jul. 2011 in the names of Michael Tsuji, et al. This patent discloses a system for changing/updating the content on a client's computer. The system does so by first establishing a HTTP connection between the client's computer and a remote application server. Once the HTTP connection is established, the remote application server creates a HyperText Markup Language (HTML) template. The application server then appends instruction sets, commands and any other forms of commands that are to be executed by the client's computer into this HTML template. The template is then transmitted to the client's computer and the receiving computer then implements the template's contents.

Another system for managing devices located behind a firewall is disclosed in US Patent Publication No. 2011/0252117 A1 published on 13 Oct. 2011 in the names of Swee Huat Sng et al. This publication discloses a system and a method for accessing a computer that is disposed behind a firewall. The system discloses that a HTTP connection between the computer and the remote server is established when the computer transmits a HTTP request to the remote server. The remote server then processes the received request and generates a script containing instruction sets when so required. The generated script is then appended to a HTTP response and transmitted to the computer.

These documents disclose systems and methods for managing devices through a firewall. However, these documents do not disclose of systems or methods to authenticate or authorize managed devices. These documents also do not disclose the subsequent rejection actions that may take place when a managed device is deemed invalid by the network management system. Therefore, those skilled in the art are constantly looking for ways to manage devices located behind a firewall in a secure and efficient manner.

### SUMMARY OF INVENTION

The above and other problems in the art are solved and an advance in the art is made in accordance with this invention. A first advantage of a network management system in accordance with embodiments of this invention is that this network management system will verify the identity of an access point and based on the outcome of the verification process, instruct a controller server within the network management system to carry out an action. A second advantage of a network management system in accordance with this invention is that access points that are deemed invalid will not occupy the network management system's resources as subsequent data packets transmitted by these invalid access points will automatically receive a HTTP status code 404 response. A third advantage of a network management system in accordance with in this invention is that access points that are deemed valid will be able to directly access the network management system's databases. Subsequent data packets from these valid access points will be directed straight to a web server for subsequent processing.

A system and method for implementing a network management system in accordance with an embodiment of this invention is provided in the following manner. A first access point establishes a connection with a firewall. Once the connection is established, the first access point then generates and transmits a first data packet to the firewall. The firewall then receives and transmits the first data packet to a controller server. The controller server will then verify the identity of the first access point based on the information contained in the received first data packet. The controller server will then carry out an action based on the outcome of the controller server's verification process.

In accordance with one of the embodiments of this invention, in order to determine the validity of the first access point, the controller server compares the information contained within the first data packet with information contained in a first database accessible by the controller server. If the controller server determines that the first access point is not a valid access point, the controller server will only transmit the first data packet to an authentication server. When the authentication server receives the first data packet, the authentication server will generate an access rejection packet. The access rejection packet will contain instructions for the action that is to be carried out by the controller server. The authentication server will then transmit the access rejection packet to the controller server. Upon receipt of the access rejection packet, the controller server will then implement the instructions contained within.

In accordance with the embodiment of this invention, the instructions will instruct the controller server to carry out an action in the following manner. The controller server will generate a Hypertext Transfer Protocol (HTTP) status code 404 and transmit the HTTP status code 404 to the first access point via the firewall. The controller server will automatically direct any data packets that are subsequently transmitted by first access point to a web server. Upon receipt of the data packets directed by the controller server, the web server will automatically generate a HTTP status code 404 and transmit the generated HTTP status code 404 to the first access point via the firewall.

In accordance with another embodiment of this invention, in order to determine the validity of the first access point, the controller server compares the information contained within the first data packet with information contained in a first database accessible by the controller server. If the controller server determines that the first access point is a valid access point, the controller server will generate an access request code. The access request code together with the first data packet will then be transmitted to an authentication server. When the authentication server receives the access request code together with the first data packet, the authentication server will generate an access acceptance packet. The access acceptance packet will contain instructions for the action that is to be carried out by the controller server. The authentication server will then transmit the access acceptance packet to the controller server. Upon receipt of the access acceptance packet, the controller server will then implement the instructions contained within.

In accordance with an embodiment of this invention, the instructions will instruct the controller server to carry out an action in the following manner. The controller server will query a database server that is operationally coupled to the controller server and to a web server to retrieve a configuration of the first access point. The database server will then store the retrieved configuration in a memory maintained by the database server. The configuration will then be transmitted to the controller server. The controller server will then direct the retrieved configuration to the web server. The web server will store the configuration of the first access point in a second database maintained by the web server. After that, the controller server will transmit a first status code to the first access point. When the first access point receives the first status code, the first access point will then transmit a second data packet to the firewall. The controller server will then instruct the firewall to automatically direct the received second data packet and subsequent data packets from the first access point to the web server.

In accordance with the embodiment of this invention, when the web server receives the second data packet, the web server will compare information contained in the second data packet with information in the second database to select a script that is to be executed by the first access point. The web server will then transmit the selected script to the first access point. The first access point may then execute the received script. The script may contain a variety of instructions that may be implemented by the first access point. In accordance with some of these embodiments, the script may contain instructions for the first access point to change its transmitting power.

In accordance with another embodiment of this invention, when the web server receives the second data packet, the web server may direct the second data packet from the web server to the database server that is operationally coupled to the web server and to the controller server. The database server may compare the information in the second data packet with the configuration information of the first access point stored in the memory of the database server to determine the validity of the configuration of the first access point. If the database server determines that the configuration of the first access point is not valid, the database server will retrieve a first configuration from the database. The database server will then transmit the first configuration to the web server. The web server will then append the first configuration to a script, and transmit the script to the first access point. Upon receiving the script, the first access point will then execute the instructions contained in the received script.

In accordance with another embodiment of this invention, when the web server receives the second data packet, the web server may direct the second data packet from the web server to the database server that is operationally coupled to the web server and to the controller server. The database server may compare the information in the second data packet with the configuration information of the first access point stored in the memory of the database server to determine the validity of the configuration of the first access point. If the database server determines that the configuration of the first access point is valid, the database server may instruct the web server to generate a first status code. The web server will then transmit the first status code to the first access point.

In accordance with an embodiment of this invention, the first status code generated by the web server or the controller server may comprise Hypertext Transfer Protocol (HTTP) status code 200.

In accordance with an embodiment of this invention, the connection between the first access point and the firewall may comprise a Hypertext Transfer Protocol (HTTP) application protocol.

In accordance with an embodiment of this invention, the first access point may comprise a wireless router.

In accordance with an embodiment of this invention, the first data packet and the second data packet may comprise Hypertext Transfer Protocol (HTTP) request verbs.

In accordance with an embodiment of this invention, the information contained in the first data packet may comprise the first access point's Media Access Control (MAC) address.

In accordance with an embodiment of this invention, the access rejection packet may comprise a RADIUS Access Reject data packet, the access request code may comprise a RADIUS Access Request data packet, and the access acceptance packet may comprise a RADIUS Access Accept data packet.

### BRIEF DESCRIPTION OF THE DRAWINGS

The above advantages and features of a method and apparatus in accordance with this invention are described in the following detailed description and are shown in the drawings:

FIG. 1 illustrating a networked system;

FIG. 2 illustrating a network management system incorporating a method and system in accordance with an embodiment of this invention;

FIG. 3 illustrating a processing system representative of processing systems in devices that perform processes for providing a method and system in accordance with an embodiment of this invention;

FIG. 4 illustrating a flow diagram of a process for authenticating an access point and for determining the subsequent action to be carried out;

FIG. 5 illustrating a flow diagram of a process for determining the validity of an access point;

FIG. 6 illustrating a flow diagram of a process for issuing instructions to reject subsequent data packets in accordance with an embodiment of this invention;

FIG. 7 illustrating a flow diagram of a process for generating a HTTP status rejection code in accordance with an embodiment of this invention;

FIG. 8 illustrating a flow diagram of a process for issuing instruction to redirect subsequent data packets in accordance with an embodiment of this invention;

FIG. 9 illustrating a flow diagram of a process for selecting a script in accordance with an embodiment of this invention; and

FIG. 10 illustrating a flow diagram of a process for updating an access point's configuration in accordance with an embodiment of this invention.

### DETAILED DESCRIPTION

This invention relates to a network management system for the management of remote networks located behind a firewall. More particularly, this invention relates to a system for the management of access points located behind a firewall whereby, the access point is authenticated by the network management system and the authenticated access point will then be connected to a web server without the need for the authentication process to be repeated. Instructions may then be transmitted from the network management system to the authenticated access point, instructing the access point to carry out a predetermined set of instruction routines or commands.

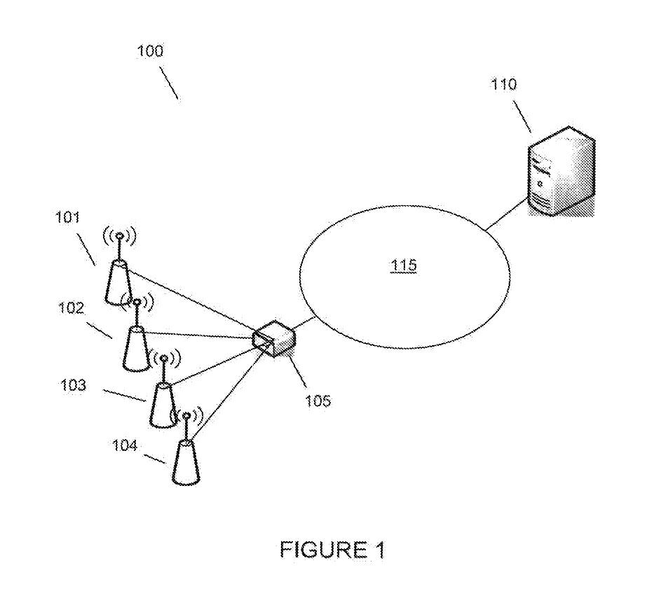

FIG. 1 illustrates network system 100. Network system 100 comprises of access points 101, 102, 103 and 104, firewall 105, external network 115 and network management system 110. Access points 101-104 are connected to firewall 105 via wireless or wired connections. One skilled in the art will recognize that access points 101-104 may be computers, wireless access points, servers, or any devices connected to firewall 105. Firewall 105 may be a switch, a router, a gateway or any means for linking multiple connections to an external network while inhibiting data that is being transferred through. Firewall 105 and network management system 110 are both connected to external network 115. External network 115 may comprise of the Internet and all external servers associated with the Internet. Firewall 105 and network management system 110 may be connected to external network 115 using wireless connections or using wired connections.

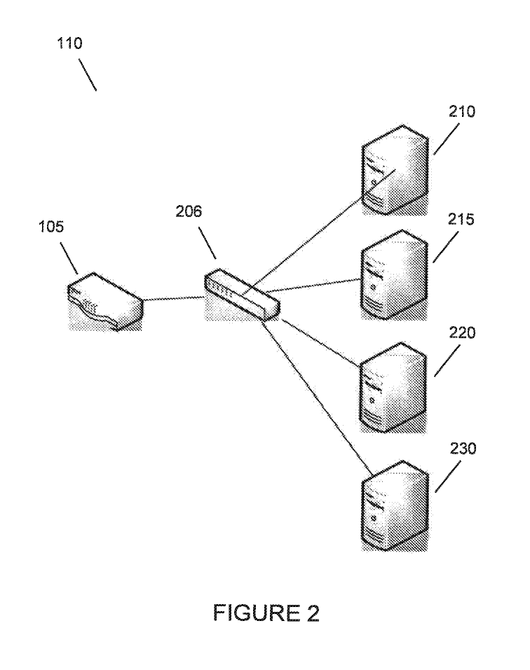

FIG. 2 illustrates network management system 110 that comprises network switch 206, controller server 210, authentication server 215, web server 220 and database server 230. Network switch 206 may further comprise a switching hub or any computer networking device that may connect to various network segments or network devices. Network switch 206 may receive and/or transmit data packets from any device connected to network switch 206. Network switch 206 then transmits the data packets only to the device for which the data packet was intended. Network switch 206 may also be incorporated in firewall 105 without departing from this invention. One skilled in the art will recognize that when reference is made to firewall 105, it may be assumed that network switch 206 has been incorporated into firewall 105. Controller server 210, authentication server 215, web server 220 and database server 230 are all linked or are operationally coupled to each other through firewall 105. Through this link, controller server 210, authentication server 215, web server 220 and database server 230 may communicate freely as required. Controller server 210, authentication server 215, web server 220 and database server 230 may comprise physical computers or computer hardware systems that execute programs to run services that serve the needs of users of other computers on the network. Controller server 210 executes a program a program to direct and process received and/or transmitted data packets. Authentication server 215 executes a program to authenticate access points based on information contained within a database and information in received data packets. Web server 220 executes a program to receive, process and transmit Hypertext Transfer Protocol (HTTP) type requests. Database server 230 executes programs to systematically store and retrieve data about access points being managed by network management system 110. One skilled in the art will recognize that other programs that perform the same functions as those described above may also be executed by controller server 210, authentication server 215, web server 220, and database server 230 without departing from this invention.

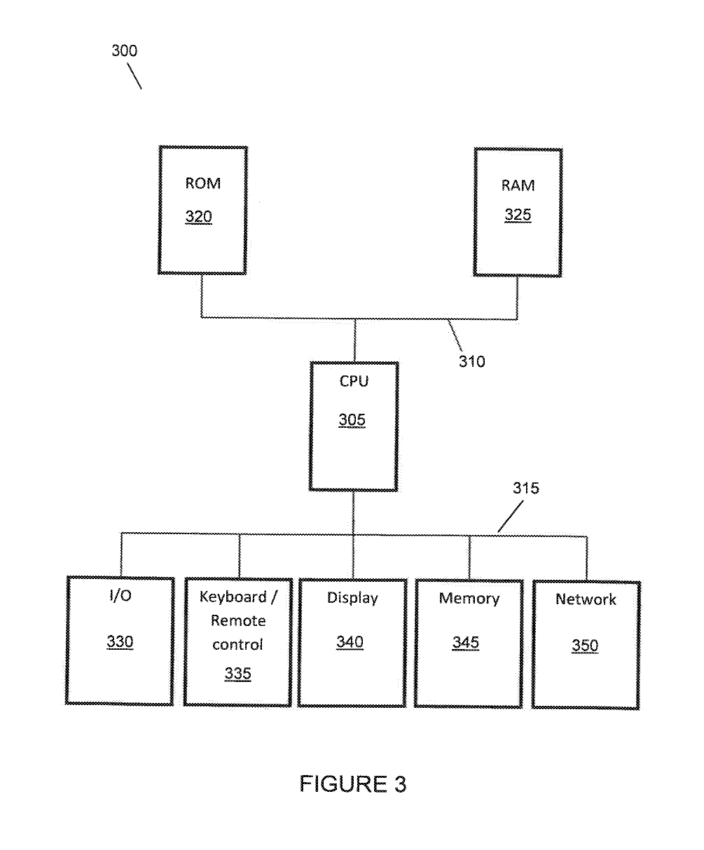

FIG. 3 illustrates a block diagram of processing system 300 that may be contained within access points 101-104, firewall 105, network switch 206, controller server 210, authentication server 215, web server 220 and database server 230. One skilled in the art will recognize that the exact configuration of each processing system may be different and the exact configuration for executing processes in accordance with this invention may vary and processing system 300 shown in FIG. 3 is provided by way of example only.

Processing system 300 includes Central Processing Unit (CPU) 305. CPU 305 is a processor, microprocessor, or any combination of processors and microprocessors that execute instructions to perform the processes in accordance with the present invention. CPU 305 connects to memory bus 310 and Input/Output (I/O) bus 315. Memory bus 310 connects CPU 305 to memories 320 and 325 to transmit data and instructions between the memories and CPU 305. I/O bus 315 connects CPU 305 to peripheral devices to transmit data between CPU 305 and the peripheral devices. One skilled in the art will recognize that I/O bus 315 and memory bus 310 may be combined into one bus or subdivided into many other busses and the exact configuration is left to those skilled in the art.

A non-volatile memory 320, such as a Read Only Memory (ROM), is connected to memory bus 310. Non-volatile memory 320 stores instructions and data needed to operate various sub-systems of processing system 300 and to boot the system at start-up. One skilled in the art will recognize that any number of types of memory may be used to perform this function.

A volatile memory 325, such as Random Access Memory (RAM), is also connected to memory bus 310. Volatile memory 325 stores the instructions and data needed by CPU 305 to perform software instructions for processes such as the processes for providing a system in accordance with this invention. One skilled in the art will recognize that any number of types of memory may be used to provide volatile memory and the exact type used is left as a design choice to those skilled in the art.

I/O device 330, keyboard 335, display 340, memory 345, network interface 350 and any number of other peripheral devices connect to I/O bus 315 to exchange data with CPU 305 for use in applications being executed by CPU 305. I/O device 330 may be any device that transmits and/or receives data from CPU 305. Keyboard 335 is a specific type of I/O device that receives user input and transmits the input to CPU 305. Display 340 receives display data from CPU 305 and displays images on a screen for a user to see. Memory 345 is a device that transmits and receives data to and from CPU 305 for storing data to a media. Network interface 350 connects CPU 305 to a network for transmission of data to and from other processing systems.

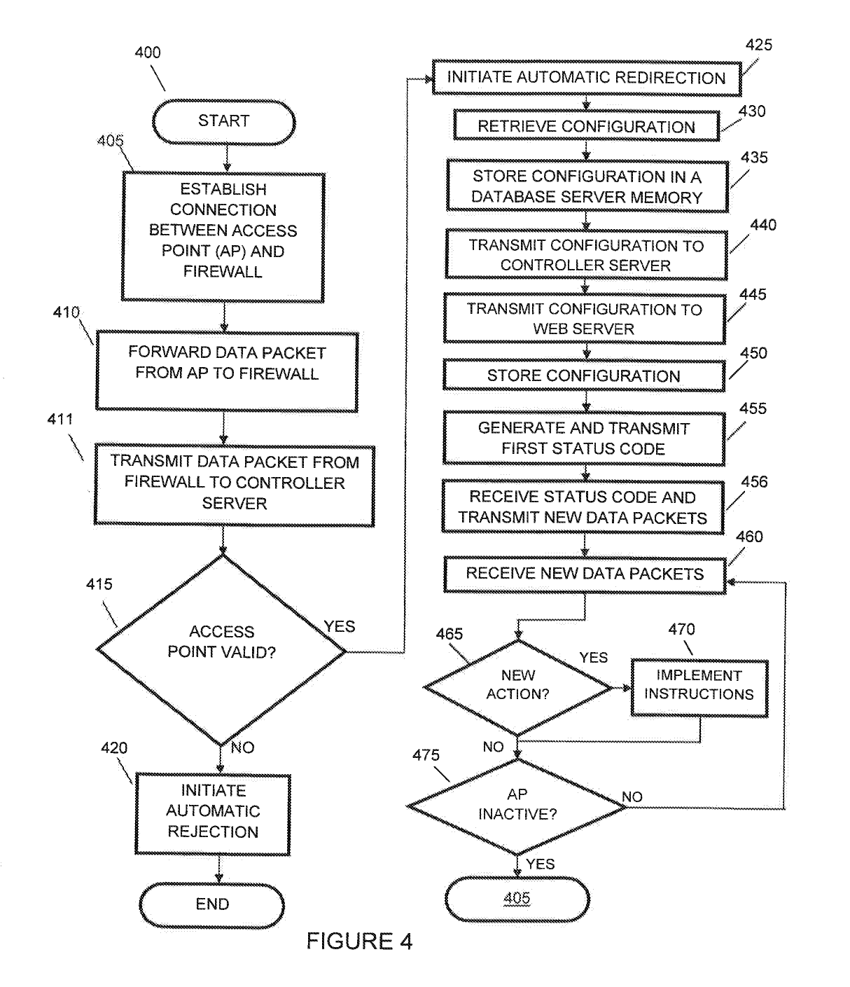

FIG. 4 illustrates a process for authenticating an access point and for determining the subsequent action that is to be carried out with regard to an authenticated access point. Process 400 begins in step 405 by establishing a connection between access point 101 and firewall 105. The connection is initiated by the access point by first selecting an appropriate communication protocol that is to be used. The communication protocol used to establish a connection between access point 101 and firewall 105 may comprise of Hypertext Transfer Protocol (HTTP) or Hypertext Transfer Protocol Secure (HTTPS). One skilled in the art will recognize that any protocol which allows inbound and outbound communications at firewalls/gateways may be used in place of the HTTP and HTTPS transport protocols without departing from this invention. Step 410 begins when a data packet is transmitted from access point 101 to firewall 105. The data packet may be transmitted in the form of HTTP request verbs such as a HTTP GET request. The data packet is then transmitted from firewall 105 to controller server 210 at step 411. Process 400 then determines at step 415 whether access point 101 is a valid access point. A valid access point is defined as an access point that resides in the records of network management system 110. If access point 101 is determined to be an invalid access point, which is if access point 101 does not exist in the records or database of network management system 110, process 400 then proceeds to step 420. At step 420, the automatic rejection process is then initiated by controller server 210. All subsequent data packets transmitted by access point 101 will then be processed by the automatic rejection process at step 420. Alternatively, if access point 101 is determined to a valid access point, process 400 then initiates the automatic redirection process at step 425. After the automatic redirection procedures have been carried out, process 400 proceeds to step 430.

At step 430, controller server 210 transmits a query to database server 230 to retrieve the present configuration of access point 101. Database server 230 which is operationally coupled to controller server 210 then retrieves the present configuration of access point 101 from a database located in database server 230. The retrieved record is then stored in a memory at database server 230 so that the record may be easily accessed by future processes at step 435. Process 400 then transmits the retrieved/stored configuration of access point 101 to controller server 210 at step 440. At step 445, controller server 210 redirects and transmits the retrieved configuration to web server 220. Web server 220 then stores the retrieved configuration in an internal database at step 450. Once this is done, process 400 proceeds to step 455 whereby a status code is transmitted by controller server 210 to access point 101 via firewall 105. The status code transmitted at this step may comprise of a HTTP Response OK code such as HTTP Status Code 200 and an authentication code. At step 456, access point 101 receives the status code transmitted by controller server 210. Access point 101 then analyzes the received status code. If the received status code indicates that access point 101 may continue transmitting data packets to network management system 110, access point 101 transmits the next data packet via firewall 105 to network management system 110. In an embodiment of this invention, subsequent data packets transmitted by access point 101 will contain the earlier received authentication code. One skilled in the art will recognize that the status code transmitted and received at steps 455 and 456 respectively may comprise of any HTTP Status Codes as long as the status code or authentication code provides an indicator to access point 101 that network management system 110 is in a ready state to receive subsequent data packets. Additionally, one skilled in the art will also recognize that the authentication code received and transmitted by access point 101 may be alphabet characters, alphanumeric characters or any other set of ANSI characters that may be received and transmitted by access point 101. In an embodiment of this invention, the HTTP status code may comprise of HTTP status code 200.

In step 456, access point 101 transmits the second data packet to network management system 110 via firewall 105. The second data packet may be transmitted in the format of a HTTP Get Request which contains additional information about access point 101 together with the earlier received authentication code. In an embodiment of this invention, the additional information may contain the Media Access Control (MAC) address of access point 101. In an embodiment of this invention, the authentication code may include the identification number of the data packet. In the described embodiment, the identification number may contain the number 2. The authentication code will be used to inform network management system 110 that the data packet originated from an authorized/validated access point. Process 400 then proceeds to step 460 whereby the second data packet is automatically directed to web server 220 without having to go through the authentication procedures set out in step 415. At step 465, if an action is required of access point 101, process 400 proceeds to step 470 before proceeding to step 475. Alternatively, if network management system 110 determines that no further action is required of access point 101, process 400 will directly proceed to step 475. At step 475, network management system 110 waits to receive subsequent data packets from access point 101. If after a predetermined period, network management system 110 does not receive any data packets from access point 101, access point 101 shall be deemed inactive. Subsequent data packets transmitted from access point 101 which is considered as inactive will then have to repeat the process for authenticating an access point and for determining the subsequent action that is to be carried out, i.e. process 400. Alternatively, if access point 101 continues transmitting data packets, access point 101 will be deemed active and process 400 will instead proceed to step 460 whereby subsequent data packets received from access point 101 are assessed in step 465.

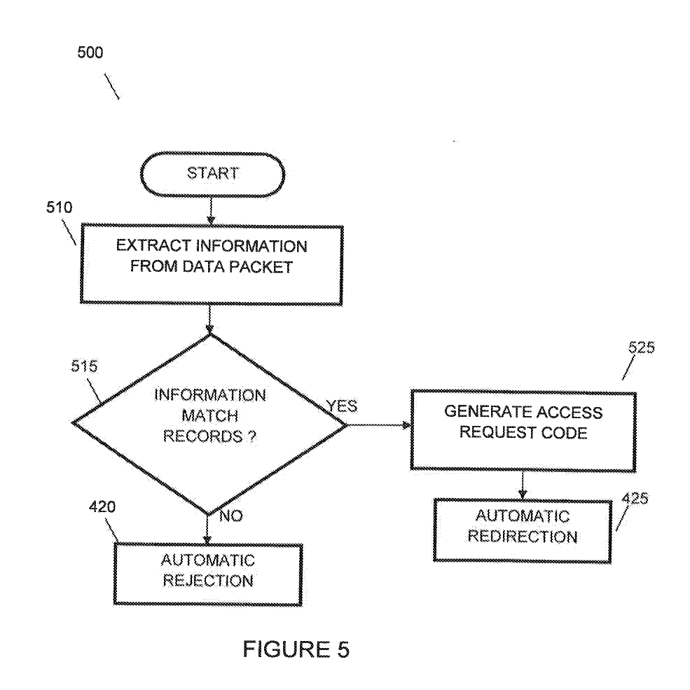

FIG. 5 illustrates a flow diagram of a verification process 500 for performing step 415 in accordance with an embodiment of this invention, which is the step whereby the validity of access point 101 is determined. One skilled in the art will recognize that other methods may be used to validate access point 101 without departing from this invention. Process 500 begins at step 510 whereby information about access point 101 is extracted from the data contained within the received data packet. At step 515, the extracted information is then compared with information contained in a database in controller server 210. This database in controller server 210 may contain various types of information about all the access points that are managed by network management system 110. If the information contained within the received data packet matches the information contained within the database at controller server 210, process 500 proceeds from step 515 to step 525. At step 525, an access request code will be generated by controller server 210. This access request code may be a type of access code that is generated by a networking protocol such as Remote Authentication Dial In User Service (RADIUS). This access request code will then be used at step 425 for the automatic redirection process of data packets. Returning to step 515, if the information contained within the received data packet does not match the information contained within the database at controller server 210, process 500 proceeds to step 420. The automatic rejection process of subsequent transmitted data packets will take place at this step. One skilled in the art will recognize that various forms of information may be extracted from the received data packet such as the MAC address of the access point that transmitted the data packet, the ID number of the data packet and various other details about the access point that transmitted the data packet.

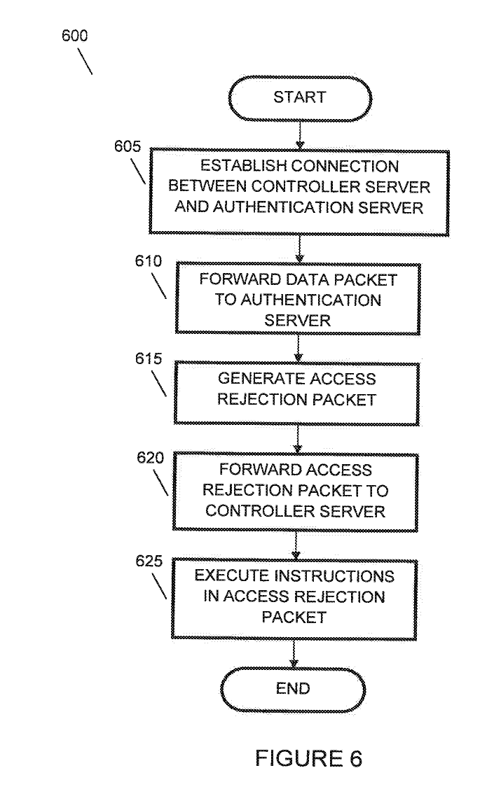

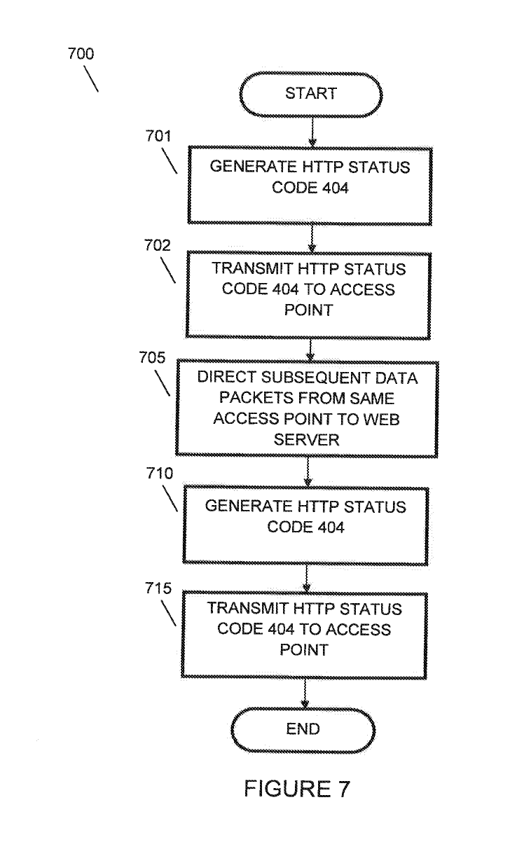

An automatic rejection process 600 for performing step 420 is illustrated in further detail in FIG. 6. Process 600 begins at step 605 by establishing a connection between controller server 210 and authentication server 215. One skilled in the art will recognize that the communication protocol used to establish a connection between controller server 210 and authentication server 215 may comprise standard internet communication protocols such as HTTP, HTTPS or TCP/IP. After the connection has been established, the received data packet is forwarded by controller server 210 to authentication server 215 at step 610. Authentication server 215 receives the data packet at step 615. As an access request was not attached together with the data packet, authentication server 215 then proceeds to generate an access rejection packet. This access rejection packet may be a type of rejection code that is generated by a networking protocol such as Remote Authentication Dial In User Service (RADIUS). Process 420 then forwards the generated access rejection packet from authentication server 215 to controller server 210 at step 620. At step 625, upon receipt of the access rejection packet by controller server 210, controller server 210 then executes the instructions contained within the rejection packet. In an embodiment of this invention, the instructions contained within the rejection packet may as illustrated in FIG. 7.

FIG. 7 illustrates an embodiment of a redirection process 700 for performing step 625 of process 600 whereby an automatic redirection process is carried out at controller server 210. Process 700 begins at step 701 whereby controller server 210 generates and transmits a HTTP status code informing access point 101 that a response was not found. The instructions in the access rejection packet provide commands for directing subsequent data packets transmitted by access point 101 to web server 220. This is done at step 705. At step 710, web server 220 receives subsequent data packets transmitted by invalid access point 101 and then generates a HTTP status code informing access point 101 that a response was not found. Process 700 then transmits the generated HTTP status code to access point 101 at step 715. The generated and transmitted HTTP status code may comprise HTTP status code 404 that informs a HTTP browser that a response was not found. In an embodiment of this invention, if the number of data packets transmitted by invalid access point 101 exceeds a predetermined threshold value, network management system 110 initiate an ignore process. In the ignore process, process 700 will skip steps 710 and 715. Instead, no responses will be sent to invalid access point 101 and invalid access point 101 will be blacklisted by network management system 110. Subsequent data packets transmitted by a blacklisted invalid access point will only be processed by network management system 110 after the administrator of network management system 110 removes the access point from the blacklist.

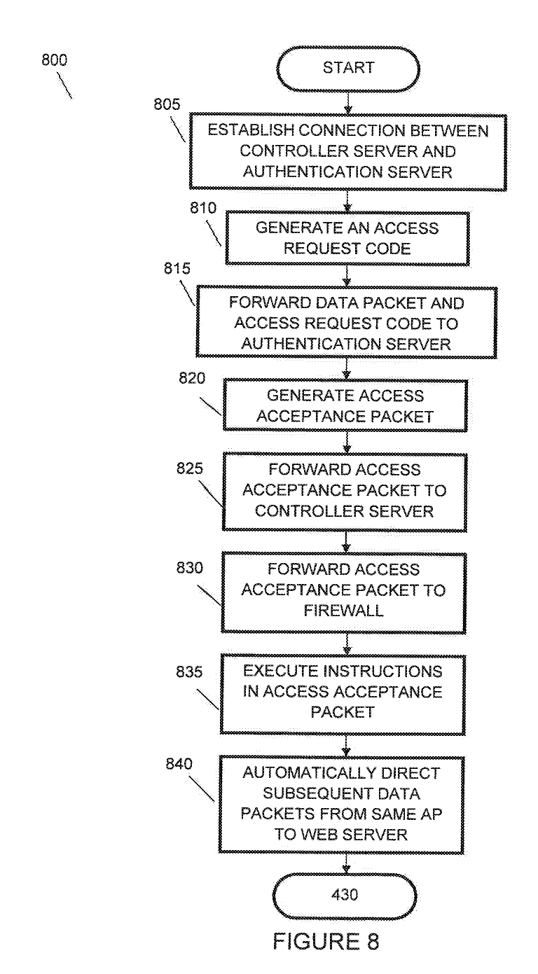

An automatic redirection process 800 for performing step 425 for validated access points is illustrated in further detail in FIG. 8. Process 800 begins with step 805 whereby a connection is established between controller server 210 and authentication server 215. One skilled in the art will recognize that the communication protocol used to establish a connection between controller server 210 and authentication server 215 may comprise standard internet communication protocols such as HTTP, HTTPS or TCP/IP. Once the connection is established, controller server 210 generates an access request code at step 810. Process 800 then forwards the data packet and the generated access request code to authentication server 215 in step 815. Upon receipt of the data packet and the access request code in step 820, authentication server 215 generates an access acceptance packet. One skilled in the art will recognize that the access request code and the access acceptance packet may be a type of access code or data packet that is generated by a networking protocol such as Remote Authentication Dial In User Service (RADIUS). The generated access acceptance packet is then forwarded to controller server 210 in step 825. The access acceptance packet is then transmitted from controller server 210 to firewall 105 at step 830. Firewall 105 then executes the instructions contained within the access acceptance packet at step 835. The instructions may include commands that will instruct firewall 105 to automatically direct all subsequent data packets from access point 101 to web server 220. This process occurs at step 840.

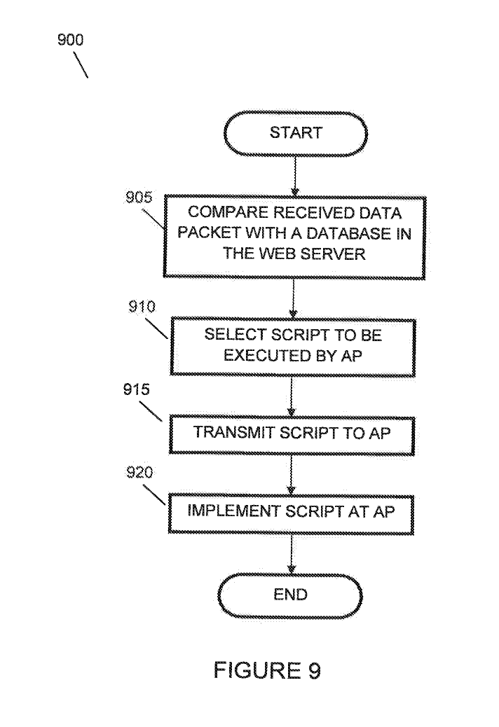

FIG. 9 illustrates process 900 in accordance with an embodiment of this invention whereby an action is required of access point 101, which is performed in step 470 of process 400. Process 900 begins with step 905 whereby a second data packet transmitted from access point 101 has been automatically redirected by firewall 105 to web server 220. In this embodiment, the second data packet is in the form of a HTTP Get request. The information in the second data packet is then compared with information contained within a database in web server 220. After the comparison has been carried out, it may be determined that an update or an action is required of access point 101. Process 900 then selects a script that is to be executed by access point 101 at step 910. This script is transmitted to access point 101 at step 915. As the second data packet was transmitted by access point 101 in the form of a HTTP Get request, the script may be appended to a HTTP Response OK and transmitted from web server 220 to access point 101. The instructions contained within the script are executed by access point 101 at step 920. In accordance with an example embodiment of this invention, the instructions in the script may instruct access point 101 to increase or decrease its transmission power accordingly.

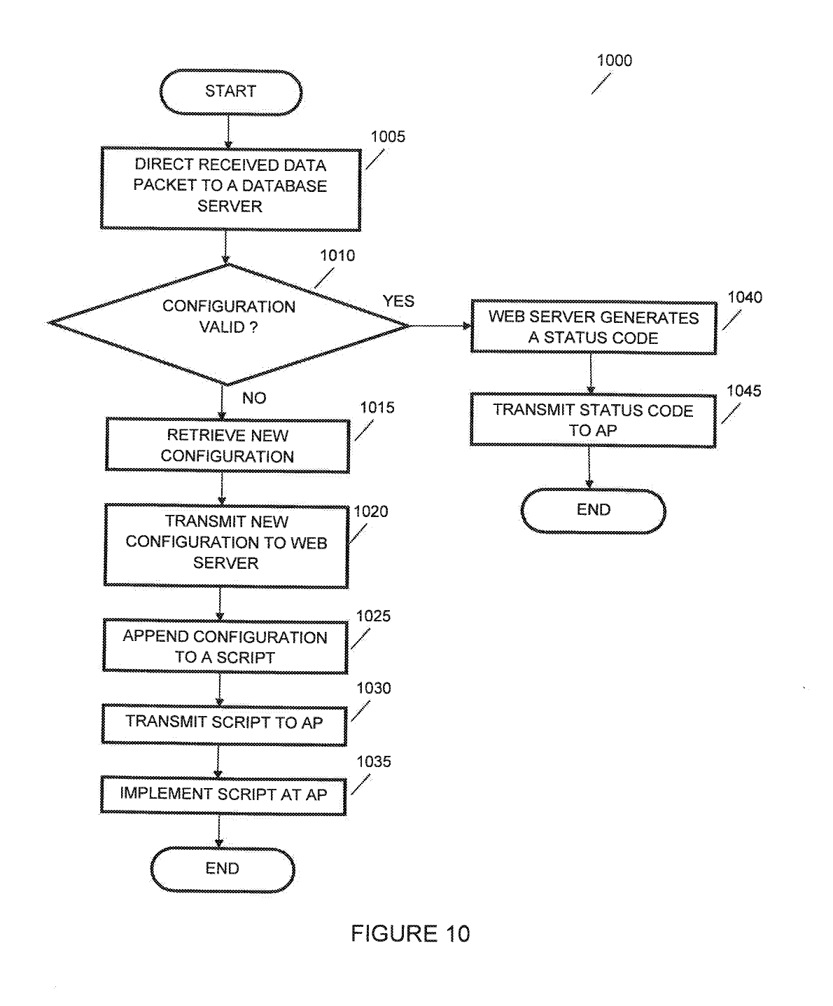

FIG. 10 illustrates a process 1000 in accordance with another embodiment of this invention whereby an action is required of access point 101 which performed in step 470 of process 400. Process 1000 begins with step 1005 whereby a second data packet transmitted from access point 101 has been automatically redirected by firewall 105 to web server 220. The second data packet is then directed from web server 220 to database server 230. At step 1010, the information contained within the second data packet is then compared with the information contained within the memory in database server 230. Information from these two sources may be used to determine the validity of the current configuration of access point 101. If it is determined that the current configuration of access point 101 is not valid, a new configuration is retrieved from the memory in database server 230 at step 1015. Process 470 then transmits the retrieved updated configuration to web server 220 at step 1020. At step 1025, the updated configuration is appended to a script. This script is then transmitted by web server 220 to access point 101 via firewall 105 at step 1030. As the second data packet was transmitted by access point 101 in the form of a HTTP Get request, the script may be appended to a HTTP Response OK and transmitted from web server 220 to access point 101 at this step. The script is then implemented at access point 101 at step 1035. If at step 1010 it is determined that the current configuration of access point 101 is valid, process 470 then proceeds to step 1040. In step 1040, database server 230 instructs web server 220 to generate a generic status code informing access point 101 that no further action is required of it at this stage. Web server 220 then transmits the status code to access point 101. The status code generated may comprise a HTTP Response OK code or HTTP status code 200.

In FIGS. 4-10, reference was made only to access point 101. One skilled in the art will recognize that this invention may be applied to access points 102, 103, 104 and other access points or devices that are to be managed by network management system 110 without departing from this invention.

The above is a description of a manner for implementing network management system in an efficient and effective manner. It is envisioned that those skilled in the art can and will design alternative systems that infringe upon this invention as set forth in the following claims.

1. A method for managing access points comprising:
establishing a connection between a first access point and a firewall;
generating and transmitting a first data packet from the first access point to the firewall in response to the establishing of the connection between the first access point and the firewall;
forwarding the first data packet received at the firewall to the controller server; and
verifying an identity of the first access point based on information contained in the first data packet and instructing a controller server to carry out an action in response to a verification of the identity of the first access point.

2. The method according to claim 1 wherein the step of verifying the identity of the first access point comprises:
comparing the information in the first data packet with a first database in the controller server to determine the identity of the first access point;
transmitting the first data packet to an authentication server in response to a negative verification of the identity of the first access point;
generating an access rejection packet in the authentication server wherein the access rejection packet contains instructions for the action to be carried out by the controller server;
transmitting the access rejection packet to the controller server in response to the generation of the access rejection packet; and
implementing the instructions in the access rejection packet in the controller server.

3. The method according to claim 2 wherein the action carried out by the controller server comprises:
generating a Hypertext Transfer Protocol (HTTP) status code 404 in response to the implementation of the instructions;
transmitting the HTTP status code 404 to the first access point via the firewall;
directing subsequent data packets received from the first access point to a web server;
generating the HTTP status code 404 in the web server; and
transmitting the HTTP status code 404 to the first access point via the firewall.

4. The method according to claim 1 wherein the step of verifying the identity of the first access point comprises:
comparing the information in the first data packet with a first database accessible by the controller server to determine the identity of the first access point;
issuing an access request code in response to a positive determination of the identity of the first access point;
transmitting the first data packet and the access request code to an authentication server;
generating an access acceptance packet in the authentication server wherein the access acceptance packet contains instructions for the action to be carried out by the controller server;
transmitting the access acceptance packet from the authentication server to the controller server;
implementing the instructions in the access acceptance packet in the controller server.

5. The method according to claim 4 wherein the action carried out by the controller server comprises:
querying a database server that is operationally coupled to the controller server and to the web server to retrieve a configuration of the first access point in response to the implementation of the instructions in the access acceptance packet in the firewall;
storing the retrieved configuration in a memory accessible by the database server;
transmitting the retrieved configuration from the database server to the controller server;
directing the retrieved configuration from the controller server to the web server;
storing the retrieved configuration of the first access point in a second database maintained by the web server;
transmitting a first status code from the controller server to the first access point in response to the storing of the configuration in the second database;
transmitting a second data packet from the first access point to the firewall in response to receiving the first status code in the first access point; and
instructing the firewall to direct the second data packet and subsequent data packets from the first access point to the web server.

6. The method according to claim 5 further comprising the steps of:
comparing data from the second data packet with data in the second database maintained by the web server to select a script that is to be executed by the first access point;
transmitting the selected script from the web server to the first access point in response to the selection of the script; and
executing the script received in the first access point.

7. The method according to claim 6 wherein the script comprises instructions to change a transmit power of the first access point.

8. The method according to claim 5 further comprising the steps of:
directing the second data packet from the web server to the database server that is operationally coupled to the web server and to the controller server;
comparing the second data packet with data stored in the memory of the database server to determine the validity of the configuration of the first access point;
retrieving an updated configuration from the database server in response to a determination that the configuration of the first access point is not valid;
instructing the web server to append the updated configuration to a script;
transmitting the script to the first access point; and
executing the script received in the first access point.

9. The method according to claim 5 further comprising the steps of:
directing the second data packet from the web server to the database server that is operationally coupled to the web server and to the controller server;
comparing the second data packet with data stored in the memory of the database server to determine the validity of the configuration of the first access point;
instructing the web server to generate the first status code in response to the determination that the configuration of the first access point is valid; and
instructing the web server to transmit the first status code to the first access point.

10. The method according to claim 9 wherein the first status code comprises Hypertext Transfer Protocol (HTTP) status code 200.

11. The method according to claim 1 wherein the connection comprises a Hypertext Transfer Protocol (HTTP) application protocol.

12. The method according to claim 1 wherein the first access point comprises a wireless router.

13. The method according to claim 1 wherein the first data packet comprises Hypertext Transfer Protocol (HTTP) request verbs.

14. The method according to claim 1 wherein the information contained in the first data packet comprises the first access point's Media Access Control (MAC) address.

15. The method according to claim 2 wherein the access rejection packet comprises a RADIUS Access Reject data packet.

16. The method according to claim 4 wherein the access request code comprises a RADIUS Access Request data packet.

17. The method according to claim 4 wherein the access acceptance packet comprises a RADIUS Access Accept data packet.

18. The method according to claim 5 wherein the second data packet comprises Hypertext Transfer Protocol (HTTP) request verbs.

19. A system for managing access points comprising:
circuitry in a first access point configured to establish a connection between the first access point and a firewall;
circuitry in a first access point configured to generate and transmit a first data packet to the firewall in response to the establishing of a connection between the first access point and the firewall;
circuitry in the firewall configured to transmit the first data packet to a controller server;
circuitry in a controller server configured to:
verify the identity of the first access point based on information contained in the first data packet; and
carry out an action in response to the verification of the identity of the first access point.

20. The system of claim 19 wherein the circuitry in the controller server configured to verify the identity of the first access point comprise:
circuitry configured to compare the information in the first data packet with information in a first database accessible by the controller server to determine the identity of the first access point;
circuitry configured to transmit the first data packet to an authentication server in response to the negative verification of the identity of the first access point;
circuitry configured to:
instruct the authentication server to generate an access rejection packet in response to the authentication server receiving the first data packet wherein the access rejection packet contains instructions for the action to be carried out by the controller server and,
transmit the access rejection packet to the controller server;
circuitry configured to receive an access rejection packet; and
circuitry configured to implement the instructions in the access rejection packet.

21. The system of claim 20 wherein the action carried out by the controller server comprises:
generating a Hypertext Transfer Protocol (HTTP) status code 404 in response to the implementation of the instructions;
transmitting the generated HTTP status code 404 to the first access point via the firewall;
directing subsequent data packets from the first access point to a web server; and
instructing the web server to:
generate a HTTP status code 404 in response to the web server receiving subsequent data packets from the first access point, and
transmit the generated HTTP status code 404 to the first access point via the firewall.

22. The system of claim 19 wherein the circuitry in the controller server configured to verify the identity of the first access point comprise:
circuitry configured to compare the information in the first data packet with information in a first database accessible by the controller server to determine the identity of the first access point;
circuitry configured to issue an access request code in response to the positive verification of the identity of the first access point;
circuitry configured to transmit the first data packet and the access request code to an authentication server;
circuitry configured to instruct the authentication server to:
generate an access acceptance packet wherein the access acceptance packet contains instructions for the action to be carried out by the controller server, and
transmit the generated access acceptance packet to the controller server; and
circuitry configured to implement the instructions in the access acceptance packet.

23. The system of claim 22 wherein the action carried out by the controller server comprises:
querying a database server that is operationally coupled to the controller server and to the web server to retrieve a configuration of the first access point in response to the implementation of the instructions;
instructing circuitry in the database server to:
store the retrieved configuration in a memory maintained by the database server, and
transmit the retrieved configuration to the controller server;
directing the retrieved configuration to the web server;
instructing circuitry in the web server to store the received configuration of the first access point in a second database maintained by the web server;
transmitting a first status code to the first access point in response to the storage of the configuration in the second database;
instructing circuitry in the first access point to transmit a second data packet to the firewall in response to receiving the first status code; and
instructing circuitry in the firewall to direct the received second data packet and subsequent data packets from the first access point to the web server.

24. The system of claim 23 wherein responsive to receiving the second data packet, the system further comprises:
circuitry in the web server configured to compare information in the second data packet with information in the second database to select a script that is to be executed by the first access point;
circuitry in the web server configured to transmit the selected script to the first access point; and
circuitry in the first access point configured to execute the script.

25. The system of claim 24 wherein the script comprises instructions to change the transmit power of the first access point.

26. The system of claim 23 wherein responsive to receiving the second data packet, the system further comprises:
circuitry in the web server configured to direct the second data packet from the web server to the database server that is operationally coupled to the web server and to the controller server;
circuitry in the database server configured to compare the information in the second data packet with the configuration information of the first wireless stored in the memory of the database server to determine the validity of the configuration of the first access point;
circuitry in database server configured to retrieve a first configuration in response to the determination that the configuration of the first access point is not valid, and to transmit the first configuration to the web server;
circuitry in the web server configured to append the first configuration to a script, and to transmit the script to the first access point; and
circuitry in the first access point configured to execute the received script.

27. The system of claim 23 wherein responsive to receiving the second data packet, the system further comprises:
circuitry in the web server configured to direct the second data packet from the web server to the database server that is operationally coupled to the web server and to the controller server;
circuitry in the database server configured to compare information in the second data packet with data stored in the memory of the database server to determine the validity of the configuration of the first access point;
circuitry in the database server configured to instruct the web server to generate a first status code in response to the determination that the configuration of the first access point is valid; and
circuitry in the web server configured to transmit the first status code to the first access point.

28. The system of claim 23 wherein the first status code comprises Hypertext Transfer Protocol (HTTP) status code 200.

29. The system of claim 19 wherein the connection comprises a Hypertext Transfer Protocol (HTTP) application protocol.

30. The system of claim 19 wherein the first access point comprises a wireless router.

31. The system of claim 19 wherein the first data packet comprises Hypertext Transfer Protocol (HTTP) request verbs.

32. The system of claim 19 wherein the information contained in the first data packet comprises the first access point's Media Access Control (MAC) address.

33. The system of claim 20 wherein the access rejection packet comprises a RADIUS Access Reject data packet.

34. The system of claim 22 wherein the access request code comprises a RADIUS Access Request data packet.

35. The method according to claim 22 wherein the access acceptance packet comprises a RADIUS Access Accept data packet.

36. The method according to claim 23 wherein the second data packet comprises Hypertext Transfer Protocol (HTTP) request verbs.
